(19) United States
(12) Patent Application Publication
(10) Pub. No.: US 2014/0359113 A1
(43) Pub. Date: Dec. 4, 2014

(54) APPLICATION LEVEL BASED RESOURCE MANAGEMENT IN MULTI-TENANT APPLICATIONS

(71) Applicants: Rouven Krebs, Ettlingen (DE); Nadia Ahmed, Karlsruhe (DE)

(72) Inventors: Rouven Krebs, Ettlingen (DE); Nadia Ahmed, Karlsruhe (DE)

(73) Assignee: SAP AG, Walldorf (DE)

(21) Appl. No.: 14/079,289

(22) Filed: Nov. 13, 2013

Related U.S. Application Data
(60) Provisional application No. 61/829,210, filed on May 30, 2013.

(51) Int. Cl. H04L 12/24; H04L 12/911

(52) U.S. Cl. CPC H04L 41/5009; H04L 47/70
USPC 709/224; 709/226

(57) ABSTRACT

A system includes multiple tenant queues, where each of the queues is associated with a single tenant is configured to queue one or more requests from its respective single tenant. One or more processing nodes have one or more shared resources for processing the requests queued in the multiple tenant queues. A first feedback loop is configured to determine a resource demand for each of the tenants. An admission controller is configured to calculate an actual utilization value of a shared resource for each of the tenants using the knowledge of resource demands for each of the tenants request from the first feedback loop and control processing of the requests from each of the tenant queues based on a reference value for each of the tenants and the actual utilization value of a shared resource for each of the tenants, where the reference value represents an allowed utilization for each of the tenants.

### CROSS REFERENCE TO RELATED APPLICATIONS

This application claims the benefit of U.S. Provisional Application No. 61/829,210, filed May 30, 2013, and titled “Application Level Based Resource Management In Multi-Tenant Applications,” which is hereby incorporated by reference in its entirety.

### TECHNICAL FIELD

This description relates to application level based resource management in multi-tenant applications.

### BACKGROUND

Cloud Computing is based on sharing resources. The sharing principle may be most beneficial on the Software as a Service (SaaS) level when a single application instance is shared. Sharing at the application level may allow a provider and customers to significantly reduce costs and maintenance efforts. This approach of sharing a single application instance is called multi-tenancy. Multi-tenancy is a principle often used in delivering SaaS where a group of users, defined as one tenant, share a single application instance with other tenants, whereas each tenant has its own view onto the application (functional and non-functional aspects).

The advantages of a multi-tenant application, namely the reduced costs due to resource sharing, should not result in performance drawbacks. Rather, performance guarantees should be provided based on service level agreements (SLAs) that may guarantee a certain response time as long as certain allowed workload intensity (quota) is not exceeded. Besides security issues, performance represents one of the major obstacles for cloud computing solutions. Especially in the context of multi-tenancy, the performance problem may be challenging since sharing is done at a high degree. This may lead to performance interference caused by disruptive tenants with high workloads, which results in a bad performance for others. Thus, performance guarantees play a crucial role in the context of cloud computing. Providers that do not respect performance expectations of their users may lose customers and reputation, which may result in serious financial losses. Thus, to ensure a good performance of multi-tenant applications, there is a desire for systems and techniques for performance isolation.

Performance isolation may be defined as follows: A system is performance isolated, if for a tenant working within their quotas, the performance is not affected when other tenants exceed their quotas. Additionally, it is possible to relate the definition to SLAs: A decreased performance for the tenant working within their quotas is acceptable as long as it is within their SLAs. A quota might refer to request rate. For the SLAs, a quota might refer to a response time, as an example.

In many cases, when a system has performance problems, increasing of the available resources can solve this problem. Respectively, a degradation of performance may be observed when resources are omitted. Resource control is an important aspect to influence the performance of a system. On the one hand, different levels of performance targets may lead to different resource requirements. Specifically, as the performance targets increase, the amount of resources required also increase. On the other hand, for a given performance target, there may be a set of different amounts of resources. In addition, one goal may be to guarantee performance isolation, which means to stay within SLAs boundaries under disruptive load.

One problem encountered is that information like the response time for requests from a tenant and his allowed request rate and the concept of a tenant itself is only available and known at the application level, i.e. SaaS. However, the resource information is known and resource control is realized at the operating system (OS)/resource level, i.e. an underlying Infrastructure as a Service (IaaS). Thus, this layer discrepancy needs to be overcome to ensure a good performance isolation of multi-tenant applications and to achieve the desire for systems and techniques for performance isolation in such applications.

### SUMMARY

According to one general aspect, a system includes multiple tenant queues, where each of the queues is associated with a single tenant is configured to queue one or more requests from its respective single tenant. One or more processing nodes have one or more shared resources for processing the requests queued in the multiple tenant queues. A first feedback loop is configured to determine a resource demand for each of the tenants. An admission controller is configured to calculate an actual utilization value of a shared resource for each of the tenants using the resource demand for each of the tenants from the first feedback loop and control processing of the requests from each of the tenant queues based on a reference value for each of the tenants and the actual utilization value of a shared resource for each of the tenants, where the reference value represents an allowed utilization for each of the tenants.

Implementations may include one or more of the following features. For example, the admission controller is configured to calculate the actual utilization value based on the processed requests from each tenant during a period of time or currently processed by the processing nodes. The admission controller is configured to calculate the actual utilization value based on estimated or measured resource demands per request for each tenant based on historical data. The admission controller controls the processing of the requests by selecting a next request to process from one of the tenant queues. The admission controller is configured to drop one or more requests from a tenant queue that exceed the allowed utilization.

The first feedback loop includes a resource demand estimator that is configured to determine the resource demand by estimating demands on each of the processor nodes per request type and per tenant.

The system may include a monitor that is operably coupled to an output of the processing nodes and to an input of the first feedback loop, where the monitor is configured to determine a quality of service for each of the tenant queues. The system may include a second feedback loop that is operably coupled to the output of the monitor and a service level agreement (SLA) controller that is coupled to the second feedback loop, where the SLA controller is configured to update the reference value for each of the tenant queues using the quality of service determined by the monitor through the second feedback loop.

In another general aspect, a computer-implemented method for executing instructions stored on a computer-readable storage device includes receiving one or more requests from multiple tenant queues, where each of the queues is associated with a single tenant and each of the queues is configured to queue one or more requests from its respective single tenant, processing the requests queued in the multiple tenant queues by one or more processing nodes, where the processing nodes comprise one or more shared resources, determining a resource demand for each of the tenants by a first feedback loop that is operably coupled to an output of the processing nodes, calculating an actual utilization value of a shared resource for each of the tenants by an admission controller using the resource demand for each of the tenants and controlling processing of the requests by the processing nodes from each of the tenant queues by the admission controller based on a reference value for each of the tenants received by the admission controller and the actual utilization value of a shared resource for each of the tenants, where the reference value represents an allowed utilization for each of the tenants.

In another general aspect, a computer program product is tangibly embodied on a computer-readable storage device and includes instructions that, when executed, are configured to receive one or more requests from multiple tenant queues, where each of the queues is associated with a single tenant and each of the queues is configured to queue one or more requests from its respective single tenant, process the requests queued in the multiple tenant queues by one or more processing nodes, wherein the processing nodes comprise one or more shared resources, determine a resource demand for each of the tenants by a first feedback loop that is operably coupled to an output of the processing nodes, calculate an actual utilization value of a shared resource for each of the tenants by an admission controller using the resource demand for each of the tenants and control processing of the requests by the processing nodes from each of the tenant queues by the admission controller based on a reference value for each of the tenants received by the admission controller and the actual utilization value of a shared resource for each of the tenants, where the reference value represents an allowed utilization for each of the tenants.

The details of one or more implementations are set forth in the accompanying drawings and the description below. Other features will be apparent from the description and drawings, and from the claims.

### BRIEF DESCRIPTION OF THE DRAWINGS

FIG. 1 is an example block diagram of a system for controlling requests in a multi-tenant system.

FIG. 2 is an example block diagram of a system for controlling requests in a multi-tenant system.

FIG. 3 is an example block diagram of multi-tenants and an admission controller of FIGS. 1 and 2.

FIG. 4 is an example algorithm of the operation of the admission controller of FIGS. 1 and 2.

FIG. 5 is an example block diagram of example operations of the systems of FIGS. 1 and 2.

FIG. 6 is an example flow chart of example operations of the systems of FIGS. 1 and 2.

### DETAILED DESCRIPTION

This document describes systems and techniques to control multi-tenant requests and shared resources in a multi-tenant environment. One goal is to control the tenant-specific resource utilization with the aim to avoid service level agreement (SLA) violations at the application level and to maintain performance isolation. Therefore, if resources consumed by a tenant can be continuously maintained approximately constant, the effect of the disturbance caused by an unpredictable workload can be reduced. Hence, when considering that the resource behavior and the response time delivered to the user have a causal relationship, the cause represented by the resource demands may be directly controlled instead of only the effect represented by response time. One advantage of this approach is that the cause may be reacted to rather than reacting to the effect. Consequently, an improvement in performance of the control mechanism may be reached, especially if an admission controller is faster than an SLA based control feedback loop, which is based on more extensive monitoring and complex algorithms.

In one example implementation, the systems and techniques described below may use one queue for each tenant in a multi-tenant environment. The resource consumption of each tenant may be estimated based on the feedback (or knowledge) of a single request for specific resource demands. In this manner, better control about how many resources are consumed by the tenants may be achieved. Additionally, the consumed resources may be calculated “online” with an admission controller selecting the next request for a tenant to be processed, which may achieve a finer grain of control when compared to other approaches. Thus, the admission control may be based at a request level. For SLA defined quotas for various shared resources, the admission controller may block requests from a tenant only if they have high demands for a resource where the quota for that tenant is already exceeded. But, the admission controller may forward requests that have only demand for resources where the quota is not already exceeded.

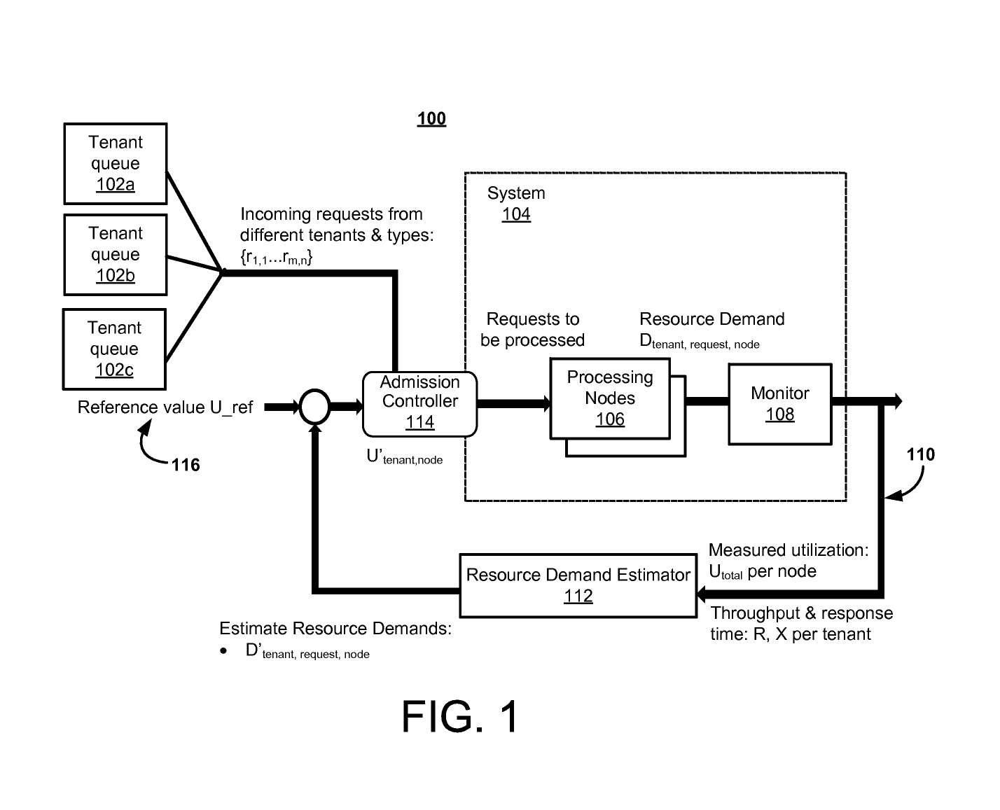

FIG. 1 is a block diagram of a system 100 for controlling requests to shared system resources in a multi-tenant environment. The system 100 includes multiple tenant queues 102a-102c. Each of the tenant queues 102a-102c is associated with a single tenant and each of the tenant queues 102a-102c is configured to queue one or more requests from its respective single tenant. The tenant queues 102a-102c may include different types of requests for different types of resources. The single tenant associated with each of the tenant queues 102a-102c may be different types of tenants from each other.

The system 100 includes a shared system 104 to process requests from the tenant queues 102a-102c. The shared system 104 includes one or more processing nodes 106 to process the requests from the tenant queues 102a-102c. The processing nodes 106 include one or more shared resources for processing the requests queued in the tenant queues 102a-102c. For example, the processing nodes 106 may include an application server and a database server that are shared among the tenants. The application server and the database server may include their respective resources such as one or more central processing units (CPUs), one or more memory devices, input/output (I/O) interfaces and/or network I/O interfaces.

The shared system 104 includes a monitor 108. The monitor 108 is operably coupled to an output of the processing nodes 106. The monitor 108 may include one or more sensors or other data collecting devices to collect information about processed requests from each of the different tenant queues 102a-102c that are associated with a respective single tenant. In one example implementation, the monitor 108 periodically collects information about processed requests of different tenants within an observation window.

The monitor 108 may be configured to determine a response time of each request from each of the tenant queues 102a-102c. The monitor 108 also may be configured to determine a throughput of each request from each of the tenant queues 102a-102c. In this manner, the monitor 108 is configured to determine a quality of service (QoS) for the requests processed from each of the tenant queues 102a-102c. The QoS may include the response time and the throughput and may include other factors that relate to and/or affect QoS. Further, the monitor 108 may measure the overall utilization of the resources that are desired to be isolated.

The system 100 includes a first feedback loop 110 that is coupled to an output of the shared system 104, including the output of the processing nodes 106 through the output of the monitor 108. The monitor 108 may be operably coupled to an input of the first feedback loop 110. The first feedback loop 110 may be configured to determine the resource demand for each of the tenants. The first feedback loop 110 also may be interchangeably referred to as an inner feedback loop throughout this document.

In one example implementation, the first feedback loop 110 may include a resource demand estimator 112. The resource demand estimator 112 may be configured to estimate the resource consumption in the processing nodes 106, including estimating the resource demand per request type from a particular tenant. The resource demand estimator 112 may estimate the demands on a resource, i, per request type, r, and tenant, k, which may be denoted as D_{r;k;i}.

The demand may refer to the amount of resources needed by a tenant. For example, the demand may refer to the amount of resources for a single request per tenant. For example, a request of type A from tenant 1 may need 100 ms of processing time of a CPU in one of the processing nodes 106.

The system 100 includes an admission controller 114. The admission controller 114 may be configured to execute one or more machine executable instructions or pieces of software, firmware, or a combination thereof. For example, the admission controller 114 may include a processor or other controller and may be configured to execute the instructions stored in a memory (not shown). The admission controller 114 may include a single processor or may include multiple processors. The admission controller 114 may interact with the other components of the system 100 to process data and to cause the other components to perform one or more actions.

The admission controller 114 is operably coupled to the tenant queues 102a-102c, the shared system 104, including the processing nodes 106 and the first feedback loop 110, including the resource demand estimator 112. The admission controller 114 receives the feedback from the first feedback loop 110 and is configured to control the processing of the requests by the processing nodes 106 from each of the tenant queues 102a-102c. In one example implementation, the tenant queues 102a-102c may be included as part of the admission controller 114, even though illustrated separately in FIG. 1.

The admission controller 114 controls the requests admission to the processing nodes 106 using a reference value U_ref 116 that is one of the inputs to the admission controller 114. The reference value U_ref 116 may represent an allowed utilization for each of the tenants. The admission controller 114 controls the requests for the processing nodes 106 using an actual utilization value of a shared resource for each of the tenants. The actual utilization value may be calculated from the resource demand from the first feedback loop 110. More specifically, the resource demand estimator 112 may forward the resource demand per request type from a particular tenant to the admission controller 114. The admission controller 114 may calculate the actual utilization using the information forwarded by the resource demand estimator 112.

Utilization may be defined as the currently (or percent (%) in period of time) allocated resources. For example, the utilization may be for a resource for one tenant. For example, a tenant that is allocated 500 ms of the CPU in a period of 1 second has a 50% utilization.

The admission controller 114 performs the admission control. Specifically, the admission controller 114 allows to admit or rejects the request from the tenant queues 102a-102c before being processed by the shared system 104. The admission controller 114 performs the admission control based on deviations to the allowed resource utilization per tenant on different resources as well as the actual resource demand which is calculated based on the per request Demands, D_{r;k;i}. Once an upper utilization limit of a certain tenant is exceeded, the admission controller 114 may drop or delay the requests if they are arriving from this tenant which results in a reduction of his utilization level.

In this manner, the admission controller 114 may regulate the request admission to maintain the SLA guarantees for each tenant in a way that requests from a tenant exceeding its allowed quota are delayed or blocked. The multi-tenant application instance includes multiple resources which are represented by the processing nodes 106. These processing nodes 106 are observed by the monitor 108, which provides the actual response time of all requests from a certain tenant, denoted as R in FIG. 1, as well as the actual throughput of all requests from certain tenant, denoted as X in FIG. 1.

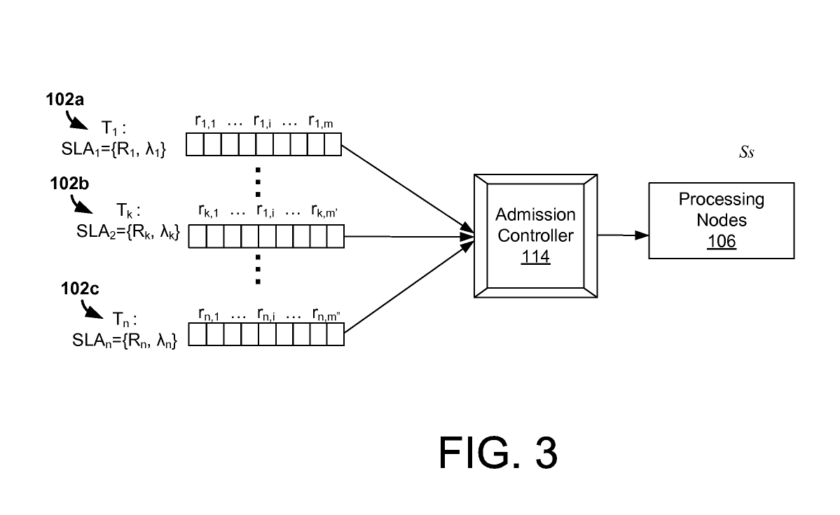

Referring also to FIG. 3, an example block diagram illustrates the more specifics of the multiple tenant queues 102a-102c, as requests are made for the resources of the processing nodes 106 through the admission controller 114. The set of tenants queues 102a-102c are represented, respectively, by T₁, Tₖ and Tₙ. Each of the tenants includes an SLA guarantee so that SLAₖ={Rₖ, λₖ}, with Rₖ being the guaranteed response time, and λₖ being the allowed request arrival rate for each tenant.

The set of arrived request of type i from the k-th tenant is denoted by rk,i with m, m′, and m″ respectively representing the total count of incoming requests per tenants. Ss is the set of servers so the S={s₁, . . . , sₚ}, which is the set of resources per processing node such as CPU, memory or I/O.

One goal may be to maintain the SLA guarantee for each tenant Tk while sending requests rk,i to the processing nodes 106. In order to reach performance isolation, the admission controller 114 may be used to select which requests are allowed to be processed on a processing node 106.

The admission controller 114 may enforce which tenant-specific subset of the arrived requests set Req from each of the tenant queues 102a-102c will be accepted so that the response time of all requests from tenants within their quota are not affected from tenants exceeding their quota. The decision to accept or reject a request depends on the actual resource utilization of the corresponding tenant, who is sending the respective request, denoted by Uk,s. If the actual utilization does not cause an SLA violation, then the request may be admitted; otherwise, the request is refused. Uk,s is calculated based on the knowledge about particular demands D_tenant, request, node and the knowledge which requests have been accepted in the past or knowledge which requests are currently processed by the processing node. The U_tenant node is calculated within the admission controller 114.

Referring back to FIG. 1, the first feedback loop 110 to make the output behave in a desired way by manipulating the input. The advantage is that it does not require accurate knowledge of the resource demands for each workload configuration, because they might by dynamically calculated for the present workload scenario and that it uses feedback to improve the performance. The mechanisms have to handle various challenges such as uncertainty, non-linearities, or time-variations. The system to be guided or regulated, denoted by P (Plant), in our case consists of both, application server and database server, which both have their respective resources such as CPU or memory. The controlled system refers to an entity on which some action is performed by means of an input, and the system reacts to this input by producing an output. The reference input represents the parameters of the SLA guarantees, i.e. the guaranteed response times and the allowed quota. The controlled output is an amount of completed requests from different tenants that cause an utilization value on the resources of both servers.

The admission controller 114 controls the requests in such a way that the consumed amount of resources does not lead to an SLA violation. The input to the controller is the so called error signal e. In one implementation, there may be two error values: (1) the difference between the allowed resource utilization that is derived from the SLA guarantee and the used resources, and (2) the percentage of quota that has been exceeded. Another implementation might calculate the percentage of quota that has been exceeded within the SLA Controller based on knowledge of the demands for each request. One purpose of the admission controller 114 could be to guarantee a desired response time under actual output of the system that is determined with by the monitor 108. Another purpose could be to guarantee the used resources for each tenant do not exceed a predefined value. Additionally, the resource demand estimator 112 can be used, if the systems output is not directly measurable. The monitor 108 measures the controlled variable and feeds the sample back to the admission controller 114.

More specifically, the admission controller 114 represents the controller component within the first feedback loop 110. The admission controller 114 aims at regulating the resource usage level for each tenant so that they comply to their SLA guarantees. Therefore, the actual value should be compared with the reference value, depending on the residual error between this values, the new control signal is transmitted to affect the system. The actual value is the resource utilization, this is derived from the resource demand estimator 112 from different tenants and requests type from last iterations. The reference value 116 is the guaranteed resource allocations which can be in percentage value (resource apportion) or in time unit (seconds) or in data volume. In this manner, one goal of the admission controller 114 is enforcing performance isolation, meaning no SLA violations, and to achieve high resource utilization that means efficient resource usage where free resources can be used.

The admission controller 114 might calculate the current utilization of a tenant based on the knowledge which requests are currently handled/were handled within the last n seconds (period) and the estimation from the resource demand estimator 112. This way it is possible to run the resource demand estimator 112 offline. This may reduce communication overheads and realizes short reactions times.

In one implementation, the admission controller 114 might work where within each period the amount of used processing time for each tenant is monitored (estimated) to check whether a given threshold/limit was already exceeded for the current period to block other requests from this tenant. Furthermore, if requests are already queued (due to an overloaded situation), the admission controller 114 might select pending requests in a way the average utilization per tenant within one period corresponds to the configured value.

Because the admission controller 114 knows about the particular demands for the various resources visited by one request it could also reschedule pending requests, drop or admit requests with reference to one single resource if it is clear that the isolation is violated at this resource. For example, if one of the resources in the processing nodes 106 is a database and if the database becomes the bottleneck, then only database heavy requests may have to be rejected from the disruptive tenant, whereas other types of requests such as to an application server resource, can still be handled without negative impact onto other tenants.

The admission controller 114 is configured to forward the incoming request from different tenant queues 102a-102c. This forwarding should guarantee the allocated resources for each tenant. Some features of the admission controller 114 are discussed as follows. The admission controller 114 may be configured to schedule requests for processing as a thread becomes free in the thread pool of the resources for the processing nodes 106.

The admission controller 114 is configured to determine which request from which tenant in the ready tenant queues 102a-102c is selected next for execution in the processing nodes 106 in an optimal way. The admission controller 114 may specify the time at which the selection function is exercised, in one of multiple different modes. For example, one mode may be a non pre-emptive mode: where a process is in the running state, it will continue until it terminates or blocks itself. For example, the requests admission mode may be a non pre-emptive mode that cannot be pre-empted when it is allocated to a resource.

In another example mode, the pre-emptive mode, the currently running process may be interrupted. In one case, pre-emption at tenant level is allowed. If a tenant is allocated to a resource, it can be interrupted and the resource is allocated to another tenant. The advantage is that the tenants who are disruptive and influencing the abiding tenants can be pre-empted. However, it may be more costly than non-pre-emptive mode due to switching time.

The admission controller 114 also includes feasibility requirements in that tenant's requests may always be scheduled. The utilization of the resource is maximal to 100%, because each tenant has a proportion of the resource derived from an SLA mapper and the sum of the guaranties is equal to 100.

The admission controller 114 also includes provisions for starvation avoidance. For example, starvation may occur when a lower priority tenant is unfairly delayed by higher priority tenant that arrive later. This occurs when a disruptive tenant monopolizes the resource because his throughput is higher. The admission controller 114 prioritizes requests to avoid this issue.

The admission controller 114 may include a priority assignment that can be static or dynamic. For example, dynamical assignment means that the priorities are calculated periodically every time the scheduler is invoked, each tenants assigned a priority which change dynamically. The admission controller 114 may assign dynamically the priorities for each tenant. The admission controller 114 is constantly updated and adjusted to reflect the resource consumption.

The admission controller 114 meets certain optimization criteria where one goal is to achieve efficient resource usage in multi-tenant applications. The admission controller 114 is designed such that the fraction of time that a resource is in use should be maximized. Therefore, the admission controller 114 attempts to keep the utilization close to 100. The admission controller 114 is configured to make scheduling decisions rapidly.

In one example implementation of the admission controller 114, the selection function is priorities based. A priority list stores a list of items with priorities for a linear order (i.e. comparison operation) is defined. Therefore, a priority scheduling is required which forwards requests with highest priority first. Tenants that are pre-emptively removed are penalized by being put in a lower priority queue. Therefore, an optimal policy for priority assignment for each tenant is required. The optimality criteria are maximizing the utilization, thereby providing higher system utilization. And minimization of performance interference between tenants so that a resource usage of a disruptive tenant should not influence the resource usage of abiding tenants. For our goal, if priority of a ready tenant rises above the priority of a currently running requests of this tenant, then this should outperform the traditional scheduling approaches.

In one implementation, the admission controller 114 solves the problem when given a shared single resource to schedule tenant specific requests, and a set R of requests, where the j-th request type from i-th tenant has a resource demand D(T_{i;Rj}). Each tenant has its specific queue 102a-102c of incoming requests to find the request of tenants specific queues that do not causes performance interference between tenants with maximal utilization. This means to find the mechanism that schedules the maximum number of requests. For example, two tenants Ti and Tr influence each other if T_{dis} is a disruptive tenant which sends more requests then allowed and T_{abi} is an abiding tenant and the P(T_{dis})>P(T_{abi}).

To solve the above problem, the admission controller 114 may implement a selection algorithm, as described below. The admission controller 114 returns the next request to be forwarded to the processing nodes 106. The decision about the tenant specific request is based on priorities. The algorithm chooses the request of a tenant queue of higher priority over one of lower priority. Once the selected request is forwarded, the priority of the tenant which sends this requests is updated.

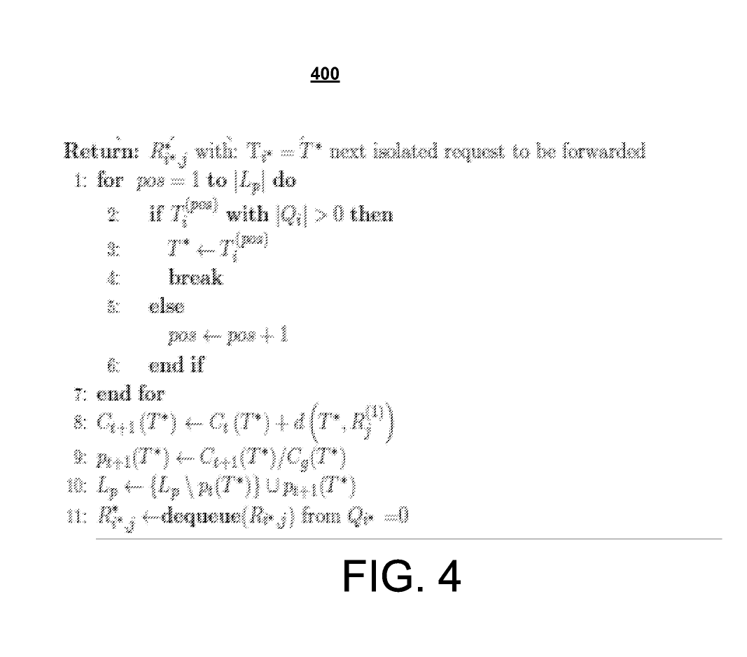

One example algorithm is illustrated in the algorithm 400 of FIG. 4.

In the first step of the algorithm 400, the sorted list of tenants priorities Lₚ is iterated through (Line 1). Where the priorities are ordered in descending order of their resource consumption ratios such that for pos=1 to |Lₚ|, P(Tᵢ^{(pos)})<P(Tₗ^{(pos+1)}). Tenants at a given level Priories P(Tₜ^{(pos)}) have precedence over all tenants at lower level Priorities P(Tₗ^{(pos)}), l<i. If some priorities are at the same level, then they can be for example ordered according to arrival time. If the priority at the current position belongs to a non empty tenant queue (Line 2). Then the current tenant is selected (Line 3). Otherwise, means the tenant has no requests in his queue, we move to the next position in the list (Line 5). This is repeated until a tenant is selected in order to assure that only non-empty tenants queues are considered. As a result, the resource demand of the first request in the selected tenant queue is accumulated to his actual resource consumption (Line 8). Furthermore, the priority of the selected queue is updated since forwarding his request increase his resource consumption. Finally, the new priority is inserted to the priorities list Lₚ such that the list is sorted by the priorities values. This assures that tenants with lower ratio between consumption and guarantied allocation have higher priorities. If the tenants completely used their guarantee, their requests are forwarded only if there is no requests from other tenants which are bellow the guarantee. This allow to efficiently use the resource.

The priority calculation performed by the admission controller 114 may be summarized as given the actual consumption of a tenant Tᵢ with his queue length |Qᵢ| and his guaranteed resource C_{g}(Tᵢ). The priority of this tenant Tᵢ is,

P:T→R

Tᵢ→P(Tᵢ)={0|Qᵢ|=0

{C_{g}(Tᵢ)/C(Tᵢ) otherwise.

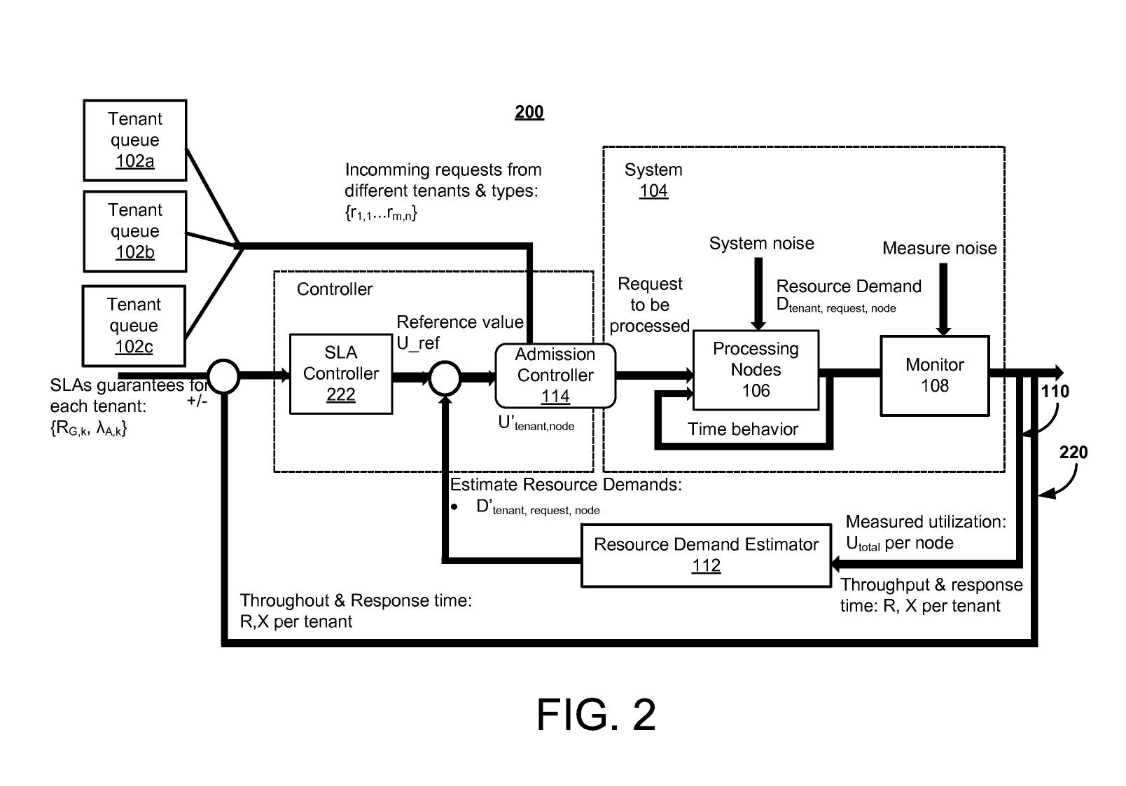

Referring to FIG. 2, an example block diagram of a system 200 illustrates the system 100 of FIG. 1, but also having a second feedback loop and an SLA controller. The components of FIG. 2 having the same reference numbers include the same features and functions of the components having the same reference numbers in FIG. 1.

In this example implementation, a second feedback loop 220 is included that is coupled to the output of the monitor 108. The SLA controller 222 is coupled to the second feedback loop, where the SLA controller 222 is configured to update the reference value for each of the tenant queues using the response time and the throughput from the monitor 108 through the second feedback loop 220. Hence, based on the difference between actual and reference value, the SLA Controller 222 dedicates an appropriate amount of resources to each tenant. Consequently, the Admission Controller 114 obtains the allowed utilization for each tenant as a reference value, represented by U_ref or, stated another way, U_{A;k} of the k-th tenant.

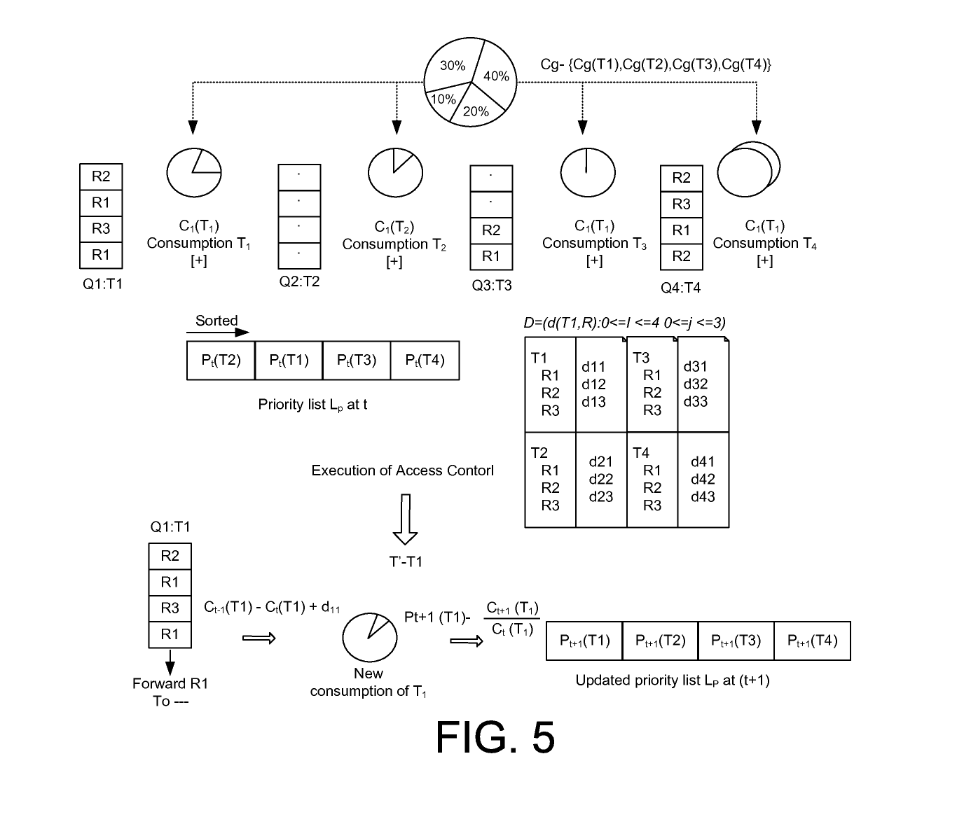

Referring to FIG. 5, a concrete example is provided for the system of FIG. 1 and FIG. 2. This section proposes a concrete example of admission control based on resource consumption of each tenant. The example consists of four tenants, respectively with guarantied amount of resources (30%; 40%; 20% and 10%) the first and the second tenants are below the guarantied amount of resources, whereby the queue of the second one is empty. The third tenant consumed completely his guarantee and the last tenant exceeds the guarantee. The priority list contains the ordered set of ratios between the consumption and the guarantees. The consumption for each tenant is the amount of consumed resource until a specified time frame. Concretely, the priority list is ordered as follow: Tenant T2 at the first position with priority Pt(T2)=8%/30=26%. Then, tenant T1 at the second position with priority Pt(T1)=4%/40%=10%. Then, tenant T3 at the third position with priority Pt(T3)=20%/20%=100%. And at the last position tenant T4 with priority Pt(T4)=15%/10%0=150%.

Besides, we have a list of resource demands for each tenant and each requests type from R1 to R3. Since the resource demands of the same request type is different for different tenants. The list contains the demands for all tenant specific requests as depicted in the right side of the FIG. 5.

Now, the admission controller 114 decides which request on the queues Q1 until Q2 can be forwarded. Therefore, the algorithm selects the lowest ratio level as well as the queue from the tenant which is not empty. It begins with the first position in the list, the priority Pt(T2) is in the first position, however the queue of this tenant is empty. Thus, the algorithm checks the next position in the list. Since the priority of the tenant T1 is at the next position and his queue Q1 contains several requests. The queue of tenant T1 is selected. Then, the algorithm look up the table with resource demands to access the demand of request type R1. Since this request in the first position in the queue. Suppose, that the demand of this request is 100 ms. And the time frame of actualizing the consumption is 1000 s, consequently the demand in percentage will be 100 1000=10%. Forwarding this request, implies change in the consumption of this tenant. Therefore, his consumption is updated as follow: Ct+1 (T1)=Ct(T1)+d11=10%+10%=20%. Then, the new priority of tenant T1 is updated as follow: pt+1(T1)=Ct+1(T1)

Cg(T1)=20% 30=66%. Finally this new priority is inserted to the list in a sorted way. Since the new priority of tenant T2 stills higher than the priority of tenant T1, it is inserted to the second position. The next time, when a resource is free, the admission controller 114 is triggered to select the next request to be forwarded depending on the actual of resource consumption of each tenant. If for example the queue Q2 is not empty due to arriving some requests, the request of this tenant will be selected because the priority is the lowest.

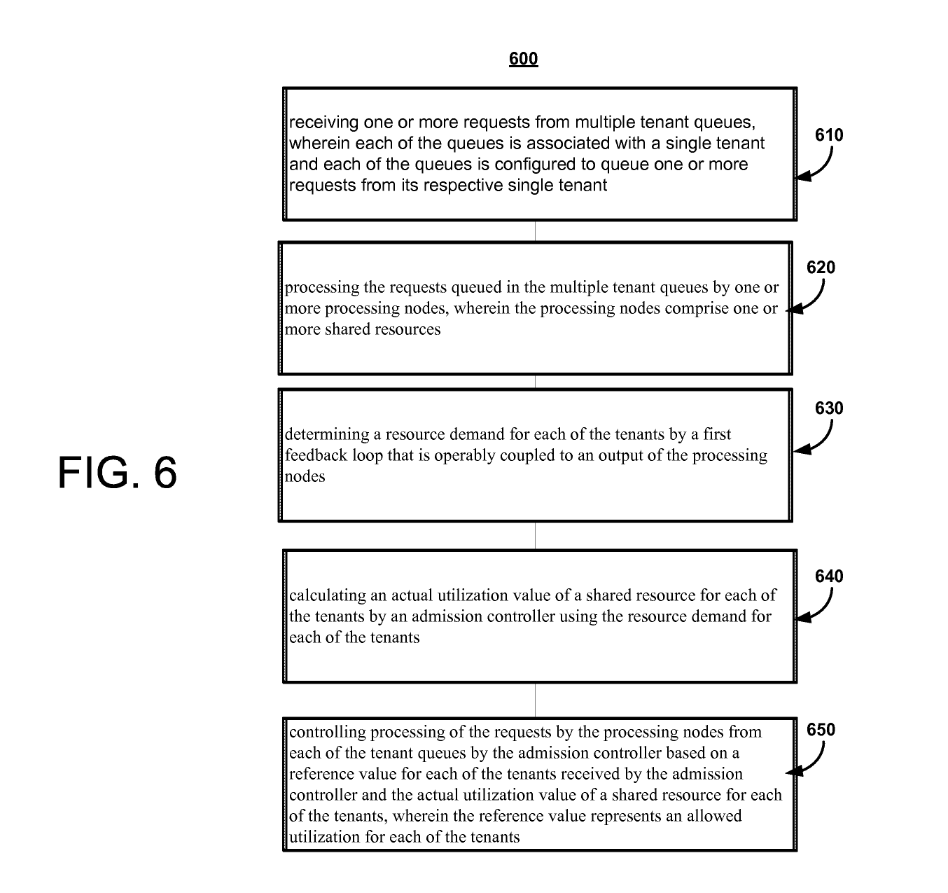

Referring to FIG. 6, an example process 600 illustrates example operations of the systems of FIGS. 1 and 2. Process 600 includes receiving one or more requests from multiple tenant queues, where each of the queues is associated with a single tenant and each of the queues is configured to queue one or more requests from its respective single tenant (610).

Process 600 includes processing the requests queued in the multiple tenant queues by one or more processing nodes, where the processing nodes comprise one or more shared resources (620).

Process 600 includes determining a resource demand for each of the tenants requests by a first feedback loop that is operably coupled to an output of the processing nodes (630).

Process 600 includes calculating an actual utilization value of a shared resource for each of the tenants by an admission controller using the resource demand for each of the tenants request (640).

Process 600 includes controlling processing of the requests by the processing nodes from each of the tenant queues by the admission controller based on a reference value for each of the tenants received by the admission controller and the actual utilization value of a shared resource for each of the tenants, where the reference value represents an allowed utilization for each of the tenants (650).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a computer-readable storage device and executable by at least one processor, the system comprising:
multiple tenant queues, wherein each of the queues is associated with a single tenant and each of the queues is configured to queue one or more requests from its respective single tenant;
one or more processing nodes, the processing nodes comprising one or more shared resources for processing the requests queued in the multiple tenant queues;
a first feedback loop that is operably coupled to an output of the processing nodes, wherein the first feedback loop is configured to determine a resource demand for each of the tenants; and
an admission controller that is operably coupled to the tenant queues, the processing nodes and the first feedback loop, wherein the admission controller is configured to:
calculate an actual utilization value of a shared resource for each of the tenants using the resource demand for each request type of the tenants from the first feedback loop, and
control processing of the requests by the processing nodes from each of the tenant queues based on a reference value for each of the tenants received by the admission controller and the actual utilization value of a shared resource for each of the tenants, wherein the reference value represents an allowed utilization for each of the tenants.

2. The system of claim 1 wherein the admission controller is configured to calculate the actual utilization value based on the processed requests from each tenant during a period of time or currently processed by the processing nodes.

3. The system of claim 1 wherein the admission controller is configured to calculate the actual utilization value based on estimated or measured resource demands per request for each tenant based on historical data.

4. The system of claim 1 wherein the admission controller controls the processing of the requests by selecting a next request to process from one of the tenant queues.

5. The system of claim 1 wherein the admission controller is configured to drop one or more requests from a tenant queue that exceed the allowed utilization.

6. The system of claim 1 wherein the first feedback loop comprises a resource demand estimator that is configured to determine the resource demand by estimating demands on each of the processor nodes per request type and per tenant.

7. The system of claim 1 further comprising a monitor that is operably coupled to an output of the processing nodes and to an input of the first feedback loop, wherein the monitor is configured to determine a quality of service for each of the tenant queues.

8. The system of claim 7 further comprising:
a second feedback loop that is operably coupled to the output of the monitor; and
a service level agreement (SLA) controller that is coupled to the second feedback loop, wherein the SLA controller is configured to update the reference value for each of the tenant queues using the quality of service determined by the monitor through the second feedback loop.

9. A computer-implemented method for executing instructions stored on a computer-readable storage device, the method comprising:
receiving one or more requests from multiple tenant queues, wherein each of the queues is associated with a single tenant and each of the queues is configured to queue one or more requests from its respective single tenant;
processing the requests queued in the multiple tenant queues by one or more processing nodes, wherein the processing nodes comprise one or more shared resources;
determining a resource demand for each of the tenants by a first feedback loop that is operably coupled to an output of the processing nodes;
calculating an actual utilization value of a shared resource for each of the tenants by an admission controller using the resource demand for each of the tenants; and
controlling processing of the requests by the processing nodes from each of the tenant queues by the admission controller based on a reference value for each of the tenants received by the admission controller and the actual utilization value of a shared resource for each of the tenants, wherein the reference value represents an allowed utilization for each of the tenants.

10. The computer-implemented method of claim 9 wherein calculating the actual utilization value comprises calculating the actual utilization value based on the processed requests from each tenant during a period of time or currently processed by the processing nodes.

11. The computer-implemented method of claim 9 wherein calculating the actual utilization value comprises calculating the actual utilization value based on estimated or measured resource demands per request for each tenant based on historical data.

12. The computer-implemented method of claim 9 wherein controlling the processing of the requests comprises selecting a next request to process from one of the tenant queues.

13. The computer-implemented method of claim 9 further comprising dropping one or more requests from a tenant queue that exceed the allowed utilization by the admission controller.

14. The computer-implemented method of claim 9 wherein determining the resource demand for each of the tenants comprises estimating demands on each of the processor nodes per request type and per tenant by a resource demand estimator within the first feedback loop.

15. The computer-implemented method of claim 9 further comprising determining a quality of service for each of the tenant queues by a monitor.

16. The computer-implemented method of claim 15 further comprising updating the reference value for each of the tenant queues using the quality of service for each tenant determined by a service level agreement (SLA) controller coupled to the monitor through a second feedback loop.

17. A computer program product, the computer program product being tangibly embodied on a computer-readable storage device and comprising instructions that, when executed, are configured to:
receive one or more requests from multiple tenant queues, wherein each of the queues is associated with a single tenant and each of the queues is configured to queue one or more requests from its respective single tenant;
process the requests queued in the multiple tenant queues by one or more processing nodes, wherein the processing nodes comprise one or more shared resources;
determine a resource demand for each of the tenants by a first feedback loop that is operably coupled to an output of the processing nodes;
calculate an actual utilization value of a shared resource for each of the tenants by an admission controller using the resource demand for each of the tenants; and
control processing of the requests by the processing nodes from each of the tenant queues by the admission controller based on a reference value for each of the tenants received by the admission controller and the actual utilization value of a shared resource for each of the tenants, wherein the reference value represents an allowed utilization for each of the tenants.

18. The computer program product of claim 17 wherein calculating the actual utilization value includes calculating the actual utilization value based on the processed requests from each tenant during a period of time or currently processed by the processing nodes.

19. The computer program product of claim 17 wherein calculating the actual utilization value comprises calculating the actual utilization value based on estimated or measured resource demands per request for each tenant based on historical data.

20. The computer program product of claim 17 wherein controlling the processing of the requests comprises selecting a next request to process from one of the tenant queues.

21. The computer program product of claim 17 further comprising instructions that, when executed, are configured to drop one or more requests from a tenant queue that exceed the allowed utilization by the admission controller.

22. The computer program product of claim 17 wherein determining the resource demand for each of the tenants comprises estimating demands on each of the processor nodes per request type and per tenant by a resource demand estimator within the first feedback loop.

23. The computer program product of claim 17 further comprising instructions that, when executed, are configured to determine a quality of service for each of the tenant queues by a monitor.

24. The computer program product of claim 23 further comprising instructions that, when executed, are configured to update the reference value for each of the tenant queues using the quality of service for each tenant determined by a service level agreement (SLA) controller coupled to the monitor through a second feedback loop.
